(19) United States
(12) Patent Application Publication
(10) Pub. No.: US 2009/0304364 A1
(43) Pub. Date: Dec. 10, 2009

(54) DIGITAL VIDEO RECORDER AND HARD DISC MANAGEMENT METHOD

(76) Inventor: Jinmo PARK, Pyeongtaek-si (KR)

Correspondence Address: BIRCH STEWART KOLASCH & BIRCH, PO BOX 747, FALLS CHURCH, VA, 22040-0747, US

(21) Appl. No.: 12/478,314

(22) Filed: Jun. 4, 2009

(30) Foreign Application Priority Data
Jun. 5, 2008 (KR) 10-2008-0052934

(51) Int. Cl. H04N 7/26

(52) U.S. Cl. 386/124; 386/E05.001

(57) ABSTRACT

A digital video recorder and a hard disc management method are disclosed, which can quickly monitor whether or not an error has occurred to data files recorded in a hard disc, without using a S.M.A.R.T technology that takes a long time to boot the system, in a manner that a digital video recorder (DVR) having a plurality of surveillance cameras connected thereto for use records and manages, in respective boxes, data files and index files of images in each hard disc, records and manages index data for the boxes for the respective hard discs by an upper index management file, and records and manages, for each hard disc, a management map file including error information for the boxes recorded and managed in the respective hard discs, whereby the recording and reproducing operations of the digital video recorder can be efficiently improved.

This nonprovisional application claims priority under 35 U.S.C. §119(a) from Patent Application No. 10-2008-0052934 filed in the Republic of Korea on Jun. 5, 2008, the entire content of which is hereby incorporated by reference.

### BACKGROUND

1. Field

Embodiments of the present invention relate to a digital video recorder and a hard disc management method, and more particularly, to a digital video recorder and a hard disc management method which allow a digital video recorder connected to a plurality of surveillance cameras used to manage and record camera image data and index data on a hard disc HDD more efficiently.

2. Related Art

Generally, in a widely used security system, surveillance cameras and a digital video recorder are connected for use. For example, as shown in FIG. 1, 16 surveillance cameras may be connected to one digital video recorder for use.

Further, unique channel numbers CH1 to CH16 are allocated to the corresponding sixteen surveillance cameras (e.g., CAM1 to CAM16), and the digital video recorder records images, captured by the respective surveillance cameras, that are received through their unique channel numbers in different storages, for example, in a plurality of hard discs (HDDs) for the respective channels.

In addition, in the digital video recorder, data files (e.g., xxxx.data) of camera images and their associated index files (e.g., xxxx.index) representing channel numbers, recording times, and so forth in each hard disc are grouped, and recorded and managed in respective boxes.

The digital video recorder (DVR) uses a hard disc monitoring technology, which is typically called “S.M.A.R.T (Self-Monitoring, Analysis, and Reporting Technology)”. The S.M.A.R.T technology takes a lot of time to fully scan the hard disc.

Especially, in a stand-alone digital video recorder using limited CPU and memory, it takes a long time to boot the system due to the application of the S.M.A.R.T, thus inefficiently delaying the surveillance and recording functions thereof.

### SUMMARY

Therefore, embodiments of the present invention has been made in an effort to solve the foregoing problem and/or others, and an embodiment of the present invention is to provide a digital video recorder and a hard disc management method and other advantages, which can quickly monitor whether or not an error has occurred to data files recorded in a hard disc without using a S.M.A.R.T technology in a manner that a digital video recorder (DVR) having a plurality of surveillance cameras connected thereto for use records and manages, in respective boxes, data files and index files of camera images in each hard disc, records and manages index data for the boxes for the respective hard discs by an upper index management file, and records and manages, for each hard disc, a management map file including health information for the boxes recorded and managed in each hard disc.

According to an embodiment of the present invention, there is a hard disc management method for a digital video recorder (DVR) having a plurality of hard discs, the method including recording and managing respective boxes containing data files and index files of images, in each hard disc; recording and managing respective index data for the respective boxes for the each hard disc using an upper index management file of the DVR; and recording and managing, for the each hard disc, a management map file including error information for the respective boxes recorded and managed in the each hard disc.

The management map file is recorded and managed in the each hard disc, and the management map file has status information for each of the respective boxes and header information recorded in the each hard disc in a form of a list.

The status information for the each of the respective boxes includes error information representing a number of error occurrences in the each of the respective boxes, and if the number of error occurrences in the each of the respective boxes is more than a predetermined number based on the error information, the each of the respective boxes is skipped in a reproducing operation of the DVR and/or an error occurrence message is displayed.

The status information for the each of the respective boxes recorded and managed in the each hard disc is collectively displayed on one screen in a form of a graph.

According to another embodiment of the present invention, there is a digital video recorder (DVR) including a plurality of hard discs; a recording/reproducing unit configured to record or reproduce images on or from the hard discs; and a controller configured to control a recording or reproducing operation of the images, wherein the controller is configured to record and manage respective boxes containing data files and index files of the images, in each hard disc, record and manage index data for the respective boxes for the each hard disc using an upper index management file of the DVR, and to record and manage, for the each hard disc, a management map file including error information for the respective boxes recorded and managed in each the hard disc.

The controller records and manages the management map file in the each hard disc and the management map file has status information for each of the respective boxes and header information recorded in the each hard disc in a form of a list.

The status information for the each of the respective boxes includes error information representing a number of error occurrences in the each of the respective boxes, and if the number of error occurrences in the each of the boxes is more than a predetermined number based on the error information, the controller is configured to control the recording/reproducing unit such that the each of the respective boxes is skipped in a reproducing operation of the DVR and/or to control a display such that an error occurrence message is displayed.

The controller is configured to control a display such that the status information for the each of the respective boxes recorded and managed in the each hard disc is collectively displayed on one screen of a display in a form of a graph.

According to another embodiment of the present invention, there is a recording and/or reproducing device including one or more non-volatile memory, each non-volatile memory storing a management map file and a plurality of image file and index file pairs, wherein the management map file includes respective status information for each of the image file and index file pairs, and the respective status information contains error information for a corresponding image file and index file pair; and a processor to use the error information in the corresponding image file and index file pair to determine whether to access the corresponding image file and index file pair when performing recording and/or reproducing operation of the device.

According to another embodiment of the present invention, there is a method of managing access in a recording and/or reproducing device having one or more non-volatile memory, including accessing the one or more non-volatile memory, each non-volatile memory storing a management map file and a plurality of image file and index file pairs, wherein the management map file includes respective status information for each of the image file and index file pairs, and the respective status information contains error information for a corresponding image file and index file pair; and determining whether to access the corresponding image file and index file pair when accessing of the one or more non-volatile memory using the error information in the corresponding image file and index file.

The digital video recorder and a hard disc management method according to the present invention can quickly monitor whether or not an error has occurred to data files recorded in a hard disc, without using the S.M.A.R.T technology that takes a long time to boot the system, in a manner that a digital video recorder (DVR) having a plurality of surveillance cameras connected thereto for use records and manages, in respective boxes, data files and index files of camera images in each hard disc, records and manages index data for the boxes for the respective hard discs by an upper index management file, and records and manages, for each hard disc, a management map file including health information for the boxes recorded and managed in each hard disc, whereby the recording and reproducing operations of the digital video recorder can be efficiently improved.

### BRIEF DESCRIPTION OF THE DRAWINGS

The embodiments of the present invention will be described in detail with reference to the following drawings in which like numerals refer to like elements.

FIG. 1 illustrates an example in which general surveillance cameras are connected to a digital video recorder for use;

FIG. 2 illustrates a construction of a digital video recorder according an embodiment of the present invention;

FIG. 3 illustrates an example embodiment in which management map files are recorded and managed according to an embodiment of the present invention;

FIG. 4 illustrates a construction of a management map file according to an embodiment of the present invention;

FIG. 5 illustrates a construction of box status information of the management map file according to an embodiment of the present invention; and

FIGS. 6 to 8 illustrate an example embodiment of an indicative image displayed on the screen according to an embodiment of the present invention.

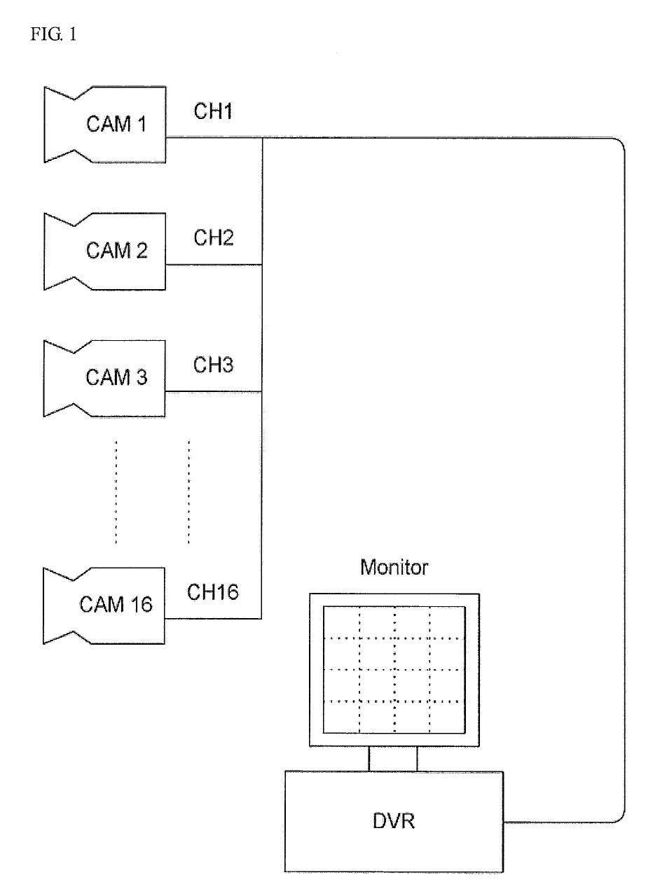

### DETAILED DESCRIPTION

Hereinafter, various embodiments of the present invention will be described in detail with reference to the attached drawings.

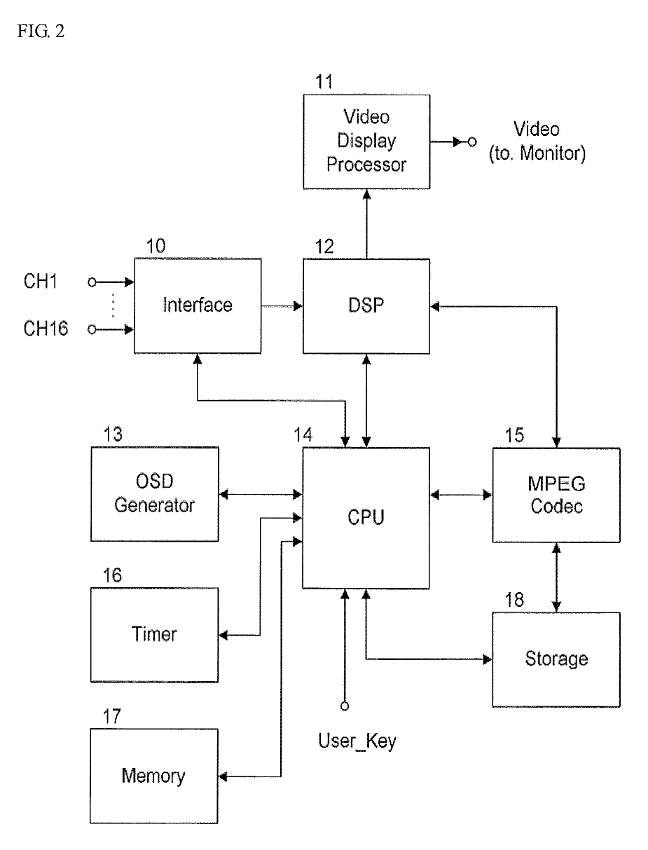

First, a digital video recorder according to an embodiment of the present invention is as shown in FIG. 2, and includes an interface unit 10, a video display processor 11, a digital signal processor 12, an on screen display (OSD) generator 13, a CPU 14, an MPEG codec 15, a timer 16, a memory 17, and a storage 18. It should be understood that additional compnents or a combination of the listed components in a single element is within the scope of the present invention.

The digital video recorder can be included in a security system, and for convenience of explanation, it is assumed that four surveillance cameras are connected to the digital video recorder for use. It should be understood that having a greater or a lesser number of the surveillance cameras is within the scope of the present invention.

Further, a display (not shown) may be connected to the digital video recorder, and accordingly, an OSD signal generated through the OSD generator 13 and/or an image signal processed by the video display processor 11 may be reproduced and/or displayed through the display (not shown).

Images captured by the surveillance cameras, and which are received through respective unique channel numbers, are inputted to the digital video recorder through the interface unit 10 and stored in the storage 18.

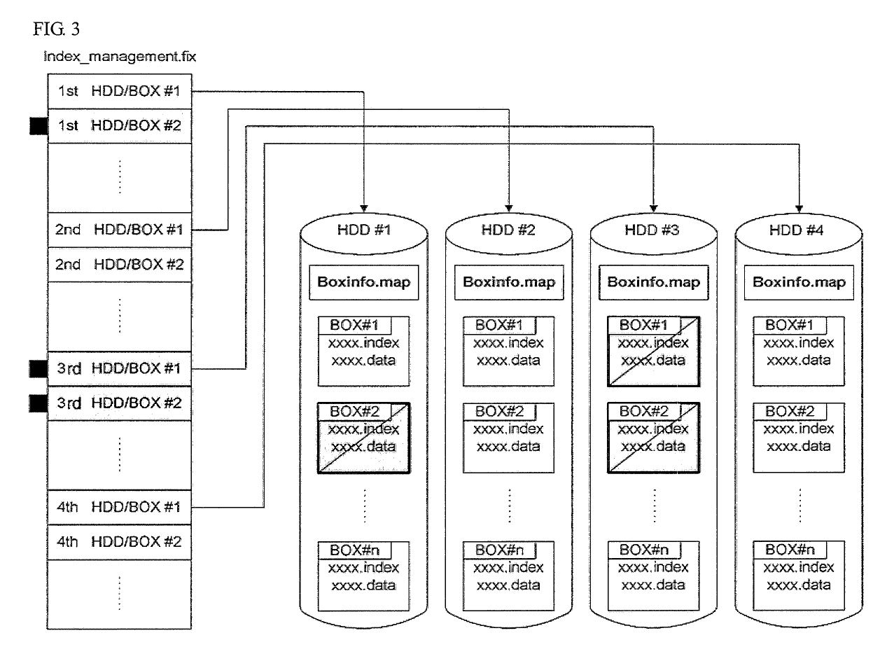

The storage 18 may comprise a plurality of hard discs, or other non-volatile memory, such as optical discs or flash memory. For instance, as shown in FIG. 3, in a case where four hard discs HDD #1˜4 are included as the storage 18, the CPU 14 groups data files (e.g., xxxx.data) of the camera images for the corresponding channels and their associated index files (e.g., xxxx.index) representing channel numbers, recording times, and so forth, and records and manages the data files and their associated index files in respective groupings referred to as boxes. In various embodiments of the present invention, additional information and/or data may be included in the boxes.

The CPU 14 is applied as a controller, and overally controls the operation of each component of the digital video recorder. Also, the CPU 14 records and manages (that is, controls the recording and managing of) index data for the boxes for respective hard discs via an upper index management file (e.g., Index_management.fix), and records and manages, for each hard disc, a management map file (e.g., Boxinfo.map) including health information for the boxes #1˜#n recorded and managed in the each hard disc. To this end, the CPU 14 controls a recording/reproducing unit which includes all other elements of the digital video recorder necessary for performing a recording or reproducing operation such as the digital signal processor 12, the MPEG codec 15, the memory 17, and the storage 18.

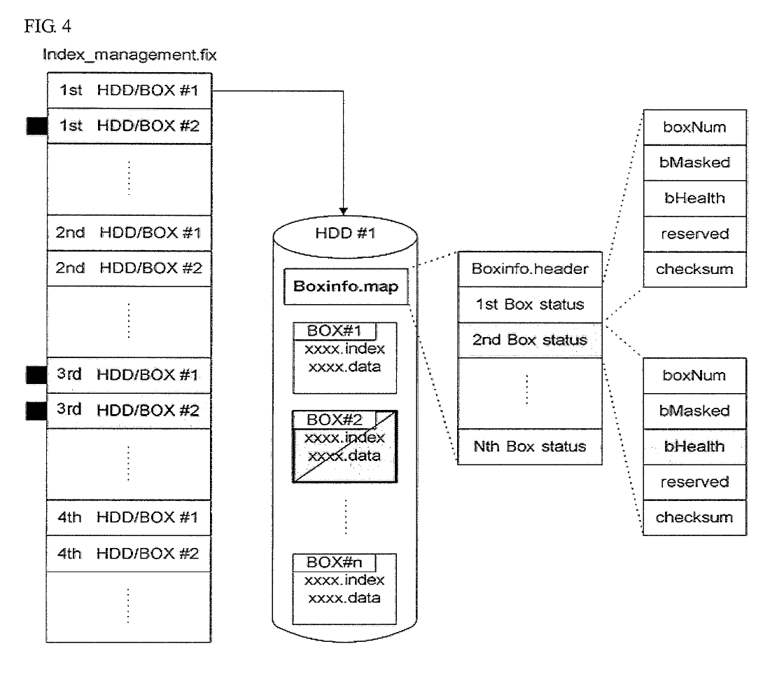

For example, as shown in FIG. 4, when the first to N-th boxes #1˜#n are recorded and managed in the first hard disc HDD #1, header information (e.g., Boxinfo.header) and status information (e.g., 1st Box status, 2nd Box status, ˜Nth Box status) of the first to N-th boxes (e.g., BOX#1, BOX#2, ˜BOX#n) are recorded and managed in the form of a table as the management map file (e.g., Boxinfo.map).

status information (such as 1st Box status) includes box number information (boxNum) representing designation number of a corresponding box, box mask information (bMasked) representing whether the corresponding box is to be shown or hidden, box health information (bHealth) representing health (or error) information of the corresponding box, a reserved area, and a checksum. The box health information may comprise a number of error occurrences, whereby the error occurrence represents an occurrence of an error (failure) in the corresponding box when an access for reading or writing is made to the corresponding box.

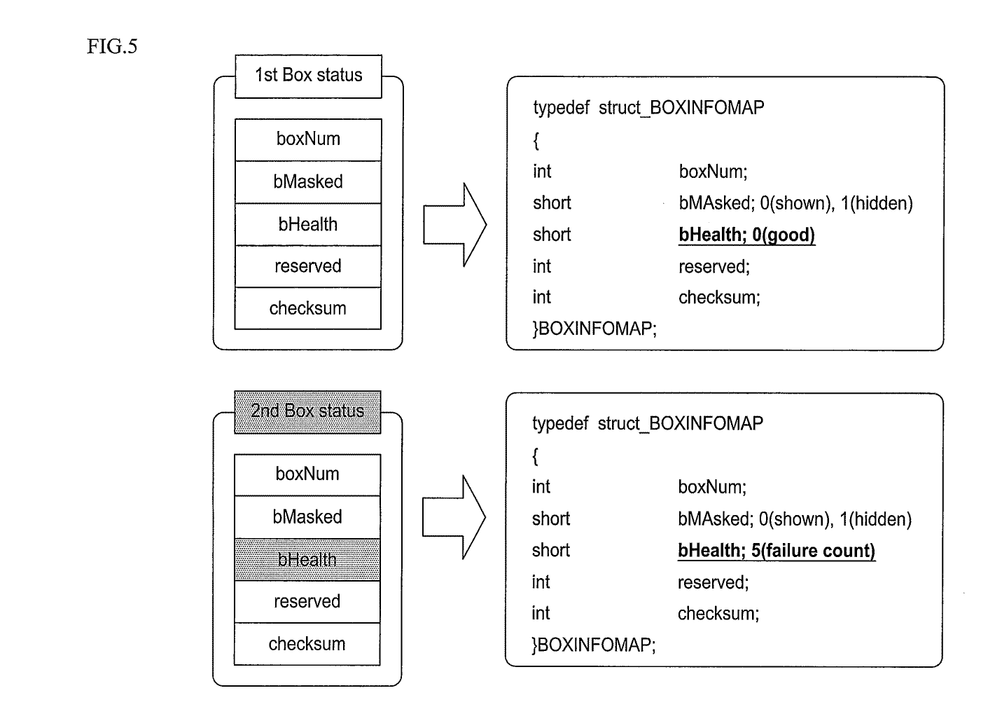

For example, as shown in FIG. 5, if no read or write error has occurred to the first box (Box #1) at all, the box health information (bHealth) included in the 1st box status information keeps a record of a value of ‘0’ indicating that the number of error occurrences is zero. This shows that the data file and index file recorded and managed in the first box (Box #1) are in good condition.

On the contrary, as shown in FIG. 5, if an error exists in the second box (Box #2), the box health information (bhealth) included in the 2nd box status information may keep a record of a determined number of error occurrences. For example, if an error occurs five times, a value of ‘5’ indicating that an error has occurred five times may be recorded. This shows that the data file and index file that are recorded and managed in the second box (Box #2) are not in good condition. That is, a quantitative indicator may be used.

As explained above, the box health information (bHealth) keeps a record of the number of error occurrences, and when the number of error occurrence exceeds a predetermined value, the CPU 14 can judge the data file and index file recorded in the corresponding box as being defective.

On the other hand, it is also possible to record, directly in the box health information (bHealth), whether the data file and index file that are recorded and managed in the corresponding box are good or not good. That is, a qualitative indicator may be used, such as binary 0 for good and binary 1 for not good, or vice versa.

Although the above description has been made with respect to the case where the box health information included in the status information of each box keeps a record of the data file and index file included in the box, or a record of the cumulative number of access errors in reproduction, it should be understood that such access errors may also include damage (crash or corruption) of the corresponding files, as well as error or failure in accessing, reading or writing to the corresponding box.

The CPU 14 efficiently and quickly detects whether an error has occurred to the boxes recorded in each hard disc by retrieving and referring to the management map files Boxinfo.map that are recorded and managed in each hard disc as described above.

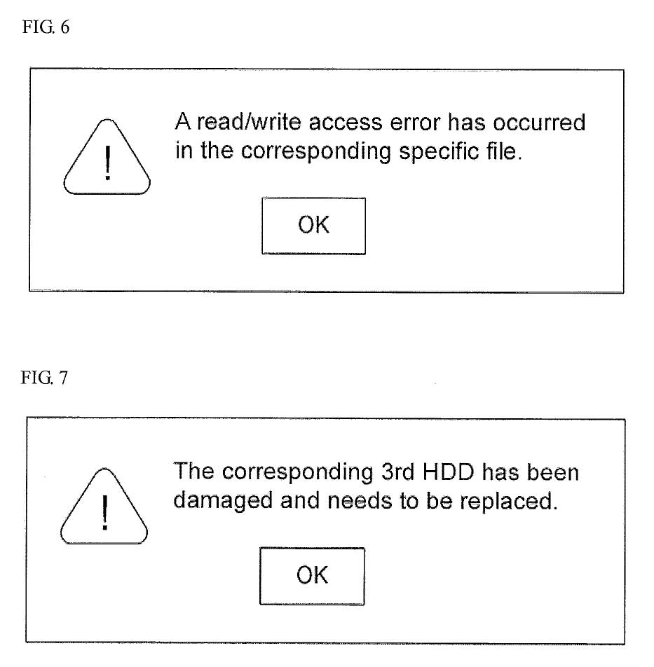

For example, the management map file (e.g., Boxinfo.map) corresponding to the first hard disc HDD #1 is retrieved to check a plurality of box status information for boxes therein. Accordingly, as shown in FIG. 5, if a value of the box health information (bHealth) included in the 2nd Box status information is a value other than ‘0’, for example, ‘5’, the CPU 14 operatively controls the OSD generator 13 to output a corresponding error message and display the error message on the display (not shown). As shown in FIG. 6 by way of example, as the error message that is generated by the OSD generator 13 and displayed on the display (not shown) according to control of the CPU 14, a message indicative of occurrence of a read/write access error in the corresponding specific file (or box) may be displayed.

Moreover, the CPU 14 may check a plurality of box status information by retrieving the management map file corresponding to an entire hard disc, such as the third hard disc HDD #3, and can inform the user if an error has occurred to a predetermined reference number of boxes. For example, if an error has occurred to 50% of the boxes recorded in the third hard disc HDD #3, the CPU 14 operatively controls the OSD generator 13 to generate an error message indicative of damage of the third hard disc HDD #3, and output and display the error message on the display (not shown). As the error message, as shown in FIG. 7, a message indicative of damage of the corresponding third hard disc HDD #3, and the need to replace the third hard disc HDD #3 can be displayed. In embodiments of the present invention, a user is able to set various modes of the digital video recorder to indicate the above discussed box error and/or hard disc error.

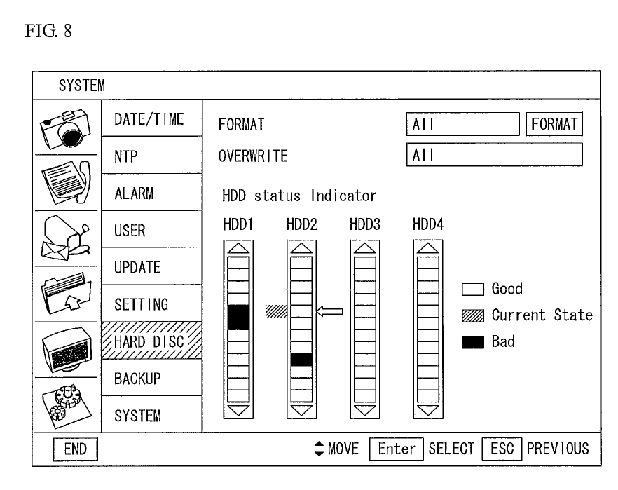

Thus, for the hard disc error, when an error status display mode is set for each hard disc according to a user's request or the like, the CPU 14 retrieves the management map files (Boxinfo.map) recorded and managed in the respective hard discs, and then operatively controls the OSD generator 13 so as to output and display an error state screen for each hard disc. For example, as shown in FIG. 8, a graph screen showing whether the boxes for the each hard disc are good or defective can be displayed on the error state screen for the each hard disc.

Moreover, for the box error, when an error monitoring mode is set according to a user's request or the like, the CPU 14 retrieves the management map files (Boxinfo.map) recorded and managed in the respective hard discs, and then blocks and skips an access to a defective box, for example, to a box having more than five errors occurred thereto as described above, when recording or reproduction data (such as image data) to or from the storage 18, to thereby prevent or reduce occurrence of an error during the recording and reproducing operations of the digital video recorder.

Consequently, it is possible to quickly monitor whether or not an error has occurred to data files (or boxes) recorded in a hard disc, without using the S.M.A.R.T technology that takes a long time to boot the system, thus improving the efficiency of recording and reproducing operations of the digital video recorder.

Although discussed in terms of a digital video recorder, embodiments of the present invention are not limited thereto, and other types of recording and/or reproducing devices are within the scope of the present invention, including computers and servers.

Additionally, although discussed in terms of the number of hard discs being equal to a number of surveillance cameras and/or channels, such is not necessary, and the number of the hard discs may be different from the number of surveillance cameras and/or the channels.

Additionally, although discussed in terms of surveillance cameras, any image capture devices are within the scope of the present invention.

Although example embodiments of the present invention described above has been disclosed for illustrative purposes, those skilled in the art can achieve various modifications, variations, substitutions or additions thereto without departing from the scope and spirit of the invention disclosed in the accompanying claims.

What is claimed is:

1. A hard disc management method for a digital video recorder (DVR) having a plurality of hard discs, the method comprising:
recording and managing respective boxes containing data files and index files of images, in each hard disc;
recording and managing respective index data for the respective boxes for the each hard disc using an upper index management file of the DVR; and
recording and managing, for the each hard disc, a management map file including error information for the respective boxes recorded and managed in the each hard disc.

2. The method of claim 1, wherein the management map file is recorded and managed in the each hard disc.

3. The method of claim 1, wherein the management map file has status information for each of the respective boxes and header information recorded in the each hard disc in a form of a list.

4. The method of claim 3, wherein the status information for the each of the respective boxes includes error information representing a number of error occurrences in the each of the respective boxes.

5. The method of claim 4, wherein if the number of error occurrences in the each of the respective boxes is more than a predetermined number based on the error information, the each of the respective boxes is skipped in a reproducing operation of the DVR and/or an error occurrence message is displayed.

6. The method of claim 3, wherein the status information for the each of the respective boxes recorded and managed in the each hard disc is collectively displayed on one screen in a form of a graph.

7. A digital video recorder (DVR), comprising:
a plurality of hard discs;
a recording/reproducing unit configured to record or reproduce images on or from the hard discs; and
a controller configured to control a recording or reproducing operation of the images,
wherein the controller is configured to record and manage respective boxes containing data files and index files of the images, in each hard disc, record and manage index data for the respective boxes for the each hard disc using an upper index management file of the DVR, and to record and manage, for the each hard disc, a management map file including error information for the respective boxes recorded and managed in each the hard disc.

8. The digital video recorder of claim 7, wherein the controller records and manages the management map file in the each hard disc.

9. The digital video recorder of claim 7, wherein the management map file has status information for each of the respective boxes and header information recorded in the each hard disc in a form of a list.

10. The digital video recorder of claim 9, wherein the status information for the each of the respective boxes includes error information representing a number of error occurrences in the each of the respective boxes.

11. The digital video recorder of claim 10, wherein if the number of error occurrences in the each of the boxes is more than a predetermined number based on the error information, the controller is configured to control the recording/reproducing unit such that the each of the respective boxes is skipped in a reproducing operation of the DVR and/or to control a display such that an error occurrence message is displayed.

12. The digital video recorder of claim 9, wherein the controller is configured to control a display such that the status information for the each of the respective boxes recorded and managed in the each hard disc is collectively displayed on one screen of a display in a form of a graph.

13. A recording and/or reproducing device, comprising:
one or more non-volatile memory, each non-volatile memory storing a management map file and a plurality of image file and index file pairs, wherein the management map file includes respective status information for each of the image file and index file pairs, and the respective status information contains error information for a corresponding image file and index file pair; and
a processor to use the error information in the corresponding image file and index file pair to determine whether to access the corresponding image file and index file pair when performing recording and/or reproducing operation of the device.

14. The recording and/or reproducing device of claim 13, wherein the processor determines not to access the corresponding image file and index file pair if the error information indicates presence of a predetermined number of errors.

15. The recording and/or reproducing device of claim 13, wherein the processor uses a plurality of the error information corresponding to a plurality of corresponding image file and index file pairs in the each non-volatile memory, to determine whether to access the each non-volatile memory when performing recording and/or reproducing operation of the device.

16. The recording and/or reproducing device of claim 13, wherein the processor determines not to access the each non-volatile memory if the plurality of error information indicates that a predetermined number of the plurality of corresponding image file and index file pairs contains errors.

17. A method of managing access in a recording and/or reproducing device having one or more non-volatile memory, the method comprising:
accessing the one or more non-volatile memory, each non-volatile memory storing a management map file and a plurality of image file and index file pairs, wherein the management map file includes respective status information for each of the image file and index file pairs, and the respective status information contains error information for a corresponding image file and index file pair; and
determining whether to access the corresponding image file and index file pair when accessing of the one or more non-volatile memory using the error information in the corresponding image file and index file.

18. The method of claim 17, wherein the determining step includes determining not to access the corresponding image file and index file pair if the error information indicates presence of a predetermined number of errors.

19. The method claim 17, further comprising determining whether to access the each non-volatile memory when accessing of the one or more non-volatile memory using a plurality of the error information corresponding to a plurality of corresponding image file and index file pairs in the each non-volatile memory.

20. The method of claim 19, wherein the determining of whether to access the each non-volatile memory includes determining not to access the each non-volatile memory if the plurality of error information indicates that a predetermined number of the plurality of corresponding image file and index file pairs contains errors.
